(19) United States
(12) Patent Application Publication
(10) Pub. No.: US 2004/0117414 A1
(43) Pub. Date: Jun. 17, 2004

(54) Method and system for automatically updating operating systems

(75) Inventors: Richard Braun, Mechanicsville, VA (US); Matthew Overstreet, Richmond, VA (US)

Correspondence Address: Finnegan, Henderson, Farabow,, Garrett & Dunner, L.L.P., 1300 I Street, N.W., Washington, DC, 20005-3315, US

(73) Assignee: Capital One Financial Corporation

(21) Appl. No.: 10/320,557

(22) Filed: Dec. 17, 2002

(51) Int. Cl. G06F 12/00

(52) U.S. Cl. 707/204

(57) ABSTRACT

Methods and systems for updating operating systems are disclosed. A computer includes a disk drive that stores an operating system to be updated. The computer creates a backup image of a first partition of the disk drive, then deletes the first partition to create free space on the disk drive. The computer also places an image of a maintenance operating system into the free space, wherein the maintenance operating system is operable to manage an operating system update. Thereafter, the computer updates the stored operating system under control of the maintenance operating system.

### FIELD OF THE INVENTION

The present invention generally relates to computer operating systems and, more particularly, to methods and systems for automatically updating operating systems.

### BACKGROUND INFORMATION

An operating system comprises software that controls the allocation and usage of hardware resources in a computing environment. Periodically, it may become necessary to update an operating system. For example, it may be desirable to periodically update an operating system to ensure the efficient use of computer resources and/or maximize the number of applications that can be run in the computer environment. The concept of updating operating systems is an emerging technology. Conventional methods of updating operating systems include standard installation, unattended installation, and image-based solutions.

A standard installation, such as that provided by Microsoft™, requires users to manually install an operating system (OS) on one computer at a time and answer a number of questions during installation. The standard installation process, however, is time-consuming, labor intensive, and requires a lot of user interaction.

An unattended (scripted) installation process may be used to perform a clean installation. A clean installation is a reinstallation of software in a manner that ensures that no application or system files from a previous installation will remain. An unattended installation functions by using a script to answer all of the questions during the installation. Unattended installation reduces the time required to respond to questions during installation and may be automated to enable multiple systems to be processed simultaneously. While unattended installation may reduce the overall time required to install and configure computers compared to some other installation methods, the process is still time-consuming and can take an hour or more per computer.

OS migration may also be performed using an image-based process. An image is a duplicate, copy, or representation of all or part of a hard or floppy disk, a section of memory or hard drive, a file, a program, or data. Image-based processes capture the contents of a master system, including the operating system, applications, and settings, and put these contents in a file that can then be used to rapidly install the files to multiple computers. Image-based processes may be automated to further reduce the total time and cost of deployment. However, a disadvantage of conventional image-based processes is that profile migration utilities need to be used in conjunction with the imaging process to preserve user data, settings, and preferences. These utilities often require excessive user interaction which introduces an opportunity for errors that may later cause problems or may result in loss of data through misapplication.

Accordingly, there is a need for improved methods and systems for updating an operating system. In addition, there is a need for methods and systems that overcome one or more of the disadvantages of prior OS updating approaches. For example, there is a need for a method and system that is capable of automatically updating an operating system and that reduces user interaction, time, cost, and/or instances of failure.

### SUMMARY OF THE INVENTION

Consistent with embodiments of the invention, methods and systems are provided for automatically updating an operating system. Embodiments of the invention include systems and methods that are adapted to update an operating system on a computer through the use of imaging and disk drive partitioning. By way of example, in one embodiment, a disk drive on the computer is partitioned so that an old operating system may be backed up while a new operating system is imaged onto the disk drive.

In accordance with an embodiment of the invention, a system is provided for updating an operating system. A computer includes a disk drive that stores an operating system to be updated. The computer creates a backup image of a first partition of the disk drive, then deletes the first partition to create free space on the disk drive. The computer also places an image of a maintenance operating system into the free space, wherein the maintenance operating system is operable to manage an operating system update. Thereafter, the computer updates the stored operating system under control of the maintenance operating system.

According to another embodiment of the invention, a method is provided for updating an operating system in a computer including a disk drive that stores an operating system to be updated. The method comprises: creating a backup image of a first partition of the disk drive; deleting the first partition to create free space on the disk drive; placing an image of a maintenance operating system into the free space, wherein the maintenance operating system is operable to manage an operating system update; and updating the stored operating system under control of the maintenance operating system.

In accordance with yet another embodiment of the invention, a method is provided for updating an operating system of a client. The method comprises: resizing a partition of a disk drive of the client to create enough first free space on the disk drive to store a backup image of the resized partition, wherein the resized partition includes an operating system to be updated; creating a new partition on the disk drive using the first free space; placing an image of the resized partition into the new partition, wherein the image of the resized partition functions as the backup image; deleting the resized partition to create second free space on the disk drive; placing an image of a maintenance operating system into the second free space, wherein the maintenance operating system is operable to manage an operating system update; imaging, under control of the maintenance operating system, a new operating system into the second free space; and removing the maintenance operating system from the second free space.

In accordance with yet another embodiment of the invention, a system is provided for updating an operating system. The system is adapted to: resize a partition of a disk drive to create enough first free space on the disk drive to store a backup image of the resized partition, wherein the resized partition includes an operating system to be updated; create a new partition on the disk drive using the first free space;

places an image of the resized partition into the new partition, wherein the image of the resized partition functions as the backup image; delete the resized partition to create second free space on the disk drive; place an image of a maintenance operating system into the second free space, wherein the maintenance operating system is operable to manage an operating system update; image, under control of the maintenance operating system, a new operating system into the second free space; and remove the maintenance operating system from the second free space.

In accordance with yet another embodiment of the invention, a method is provided for updating an operating system of a client. The method comprises: resizing a partition of a disk drive of the client to create enough first free space on the disk drive to store a backup image of the resized partition, wherein the resized partition includes an operating system to be updated; creating a new partition on the disk drive using the first free space; placing an image of the resized partition into the new partition, wherein the image of the resized partition functions as the backup image; deleting the resized partition to create second free space on the disk drive; and imaging, under control of a maintenance operating system, a new operating system into the second free space, wherein the maintenance operating system is operable to manage an operating system update.

In accordance with yet another embodiment of the invention, a method is provided for updating an operating system of at least one client. The method comprises: identifying at least one client for an operating system update; and sending each of the identified clients a command to commence an operating system update. In one embodiment, each of the identified clients is operable to: create a backup image of a first partition of a disk drive on the identified client; delete the first partition to create free space on the disk drive; place an image of a maintenance operating system into the free space, wherein the maintenance operating system is operable to manage an operating system update; and update an operating system stored on the disk drive under control of the maintenance operating system.

In accordance with yet another embodiment of the invention, a method is provided for updating an operating system of at least one client. The method comprises: identifying at least one client for an operating system update; and sending each of the identified clients a command to commence an operating system update. In one embodiment, each of the identified clients is operable to: resize a partition of a disk drive of the identified client to create enough first free space on the disk drive to store a backup image of the resized partition, wherein the resized partition includes an operating system to be updated; create a new partition on the disk drive using the first free space; place an image of the resized partition into the new partition, wherein the image of the resized partition functions as the backup image; delete the resized partition to create second free space on the disk drive; place an image of a maintenance operating system into the second free space, wherein the maintenance operating system is operable to manage an operating system update; image, under control of the maintenance operating system, a new operating system into the second free space; and remove the maintenance operating system from the second free space.

It is to be understood that both the foregoing general description and the following detailed description are exemplary and explanatory only, and should not be considered restrictive of the scope of the invention, as described. Further, features and/or variations may be provided in addition to those set forth herein. For example, embodiments of the invention may be directed to various combinations and subcombinations of the features described in the detailed description.

### BRIEF DESCRIPTION OF THE DRAWINGS

The accompanying drawings are incorporated in and constitute a part of this specification and, together with the description, illustrate various features and embodiments of the invention. In the drawings:

FIG. 1 is a diagram of an exemplary network environment in which certain embodiments of the present invention may be implemented;

FIG. 2 is a diagram of an exemplary client, consistent with embodiments of the present invention;

FIG. 3 illustrates a flowchart associated with a generic exemplary method for updating an operating system, consistent with embodiments of the present invention;

FIGS. 4A, 4B, 4C, and 4D illustrate flowcharts associated with an exemplary method for client-initiated updating of an operating system, consistent with embodiments of the present invention;

FIG. 5 is a diagram of an exemplary hard drive configuration before updating has begun, consistent with embodiments of the present invention;

FIG. 6 is a diagram of an exemplary hard drive configuration after creation of a backup partition, consistent with embodiments of the present invention;

FIG. 7 is a diagram of an exemplary hard drive configuration after a maintenance operating system has been added to free space, consistent with an embodiments of the present invention;

FIG. 8 is a diagram of an exemplary hard drive configuration after a new operating system has been deployed to free space, consistent with embodiments of the present invention;

FIG. 9 is a diagram of an exemplary hard drive configuration after a maintenance operating system has been removed, consistent with embodiments of the present invention; and

FIG. 10 illustrates a flowchart associated with an exemplary method for server-initiated updating of an operating system, consistent with embodiments of the present invention.

### DETAILED DESCRIPTION

The following detailed description of the invention refers to the accompanying drawings. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

### Overview

Methods and systems consistent with the principles of the invention update an operating system in a computer. The computer resizes a partition of a disk drive of the computer to create enough first free space on the disk drive to store a backup image of the resized partition, wherein the resized partition includes an operating system to be updated. The computer then creates a new partition on the disk drive using the first free space and places an image of the resized partition into the new partition, wherein the image of the resized partition functions as the backup image. The computer also deletes the resized partition to create second free space on the disk drive and places an image of a maintenance operating system into the second free space, wherein the maintenance operating system is operable to manage an operating system update. Thereafter, the computer images, under control of the maintenance operating system, a new operating system into the second free space and removes the maintenance operating system from the second free space.

### System Environment

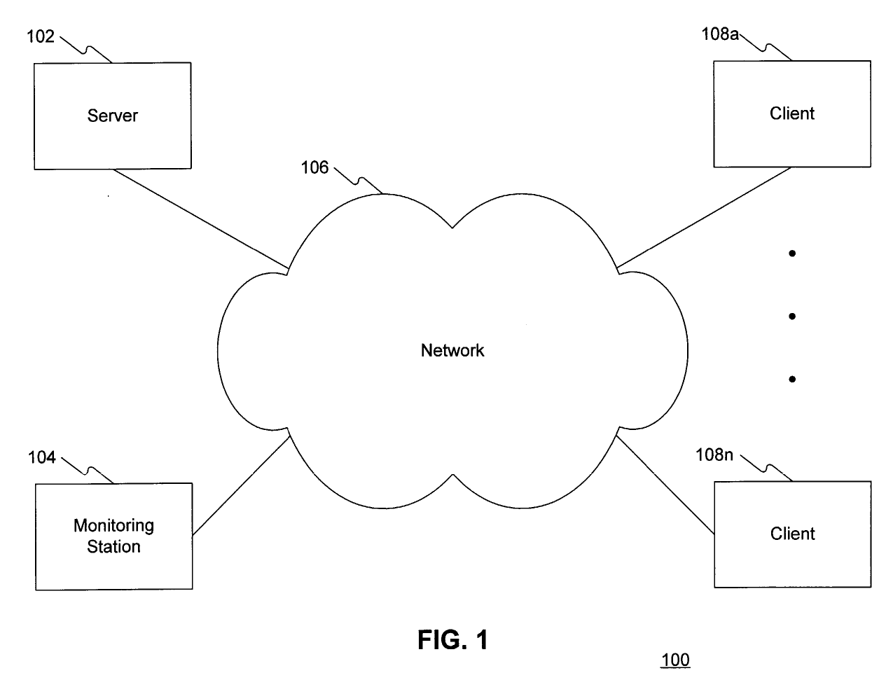

FIG. 1 is a diagram of an exemplary network environment 100 in which features and embodiments of the present invention may be implemented. Network environment 100 includes a server 102, a monitoring station 104, a network 106, and a set of clients 108a through 108n. The components of FIG. 1 may be implemented through hardware, software, and/or firmware. The number of components in network environment 100 is not limited to what is shown and other variations in the number and arrangement of the components are possible, consistent with embodiments of the present invention.

Server 102 may include software that controls or otherwise makes available a process for automatically updating an operating system that is resident on, for example, one or more of clients 108a-108n. This automatic updating may be initiated by either client 108 or server 102. In one embodiment, server 102 may initiate updating by informing a client 108 that it is time to start the process. This may be done as part of regular machine maintenance or as a way of starting large batches of updates. The client 108 may report data back to the server 108 to allow an administrator to view each machine as it progresses through the update. This allows the administrator to detect problems as the updates occur, as well as potentially start maintenance on machines that have problems completing the process.

Monitoring system 104 may be operable to maintain a log of activities during the updating of the operating systems on clients 108a-108n. For example, a log of activities may include information indicative of a status of one or more operating system updates. Although monitoring station 104 has been depicted as being separate from server 102 and clients 108a-108n, one of ordinary skill in the art will recognize that server 102 and/or one or more of the clients 108a-108n could include a similar monitoring function, in addition to or instead of monitoring station 104.

Monitoring station 104 may receive information to create the log from clients 108a-108n via network 106. Network 106 may comprise a public and/or private network that are implemented through any suitable combination of wired and/or wireless communication networks. By way of example, network 106 may be implemented through a local area network (LAN), an intranet and/or the Internet.

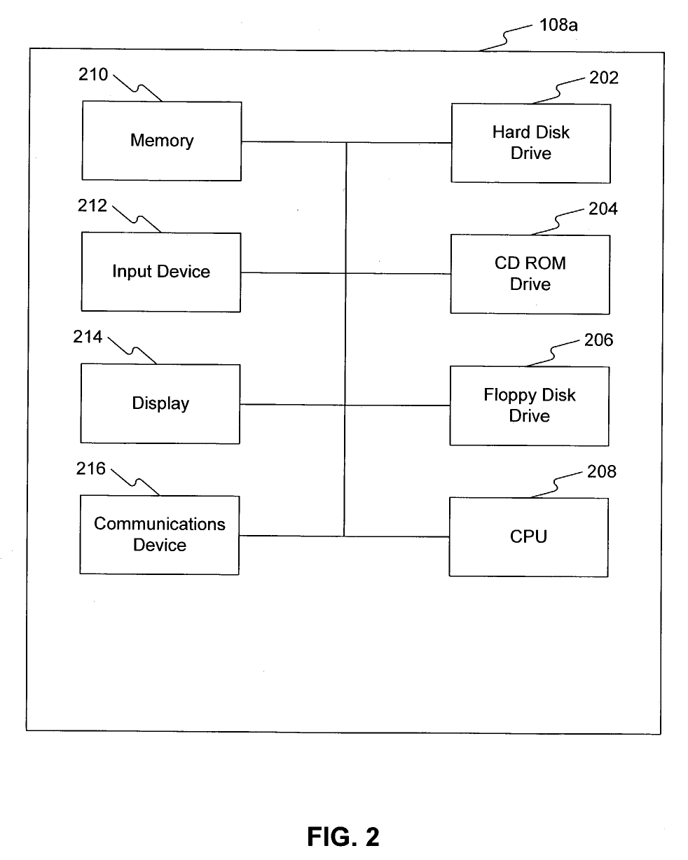

FIG. 2 is a diagram of an exemplary client, consistent with embodiments of the present invention. As illustrated in FIG. 2, the client, such as client 108a, may include a number of components, such as a hard disk drive 202, a CD ROM drive 204, a floppy disk drive 206, a CPU 208, a memory 210, an input device 212, a display 214, and/or a communications device 216. One or more of these components may be substituted, removed or modified as needed. Further, other components may be added or incorporated into the client, consistent with embodiments of the invention. Moreover, as will be appreciated by those skilled in the art, the client and its associated components may be implemented using a workstation, a personal computer, a laptop or any other type of computing platform.

CPU 208 may be one or more known processing devices, such as a microprocessor from the Pentium family manufactured by Intel™. Memory 210 may be one or more storage devices configured to store information used by CPU 208 to perform certain functions related to embodiments of the present invention. Memory 210 may be a magnetic, semiconductor, tape, or optical type of storage device. Hard disk drive 202 may also be implemented with similar storage devices.

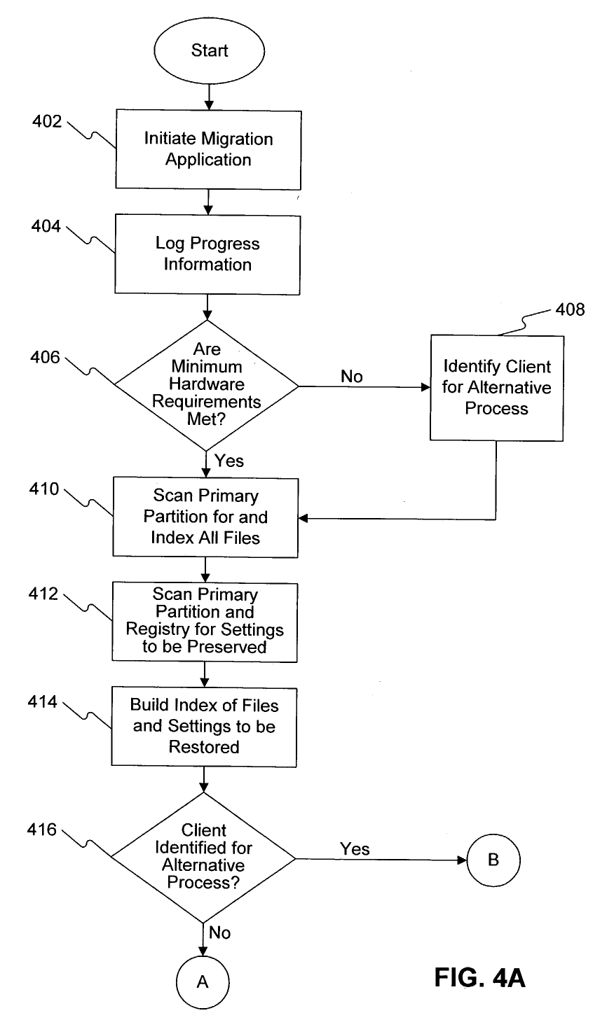

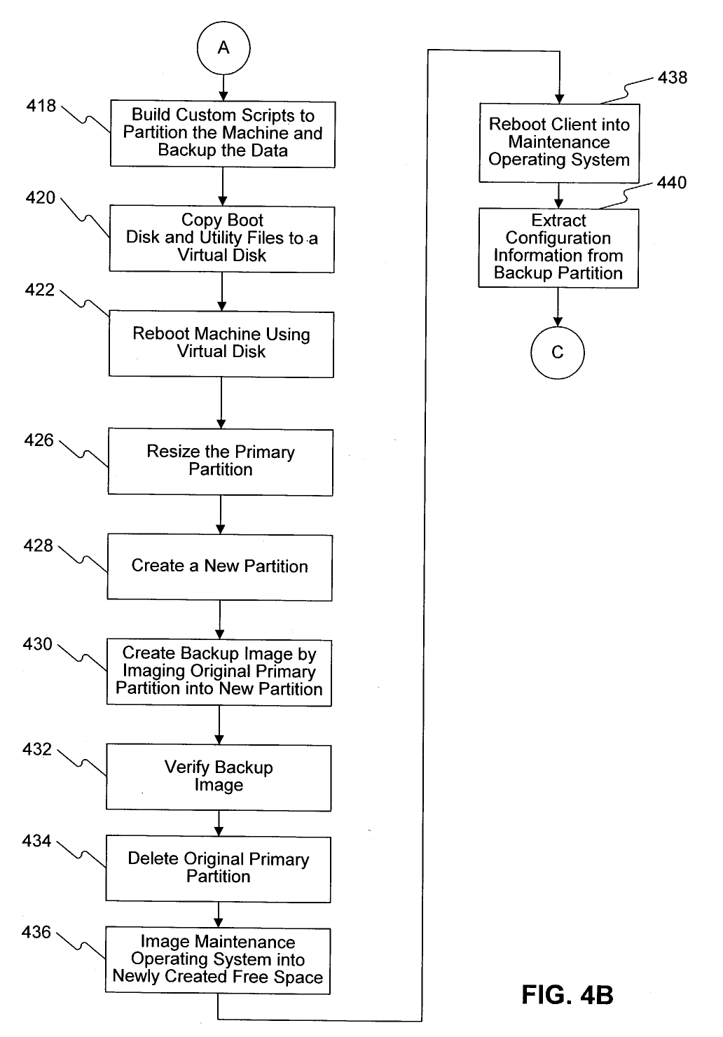

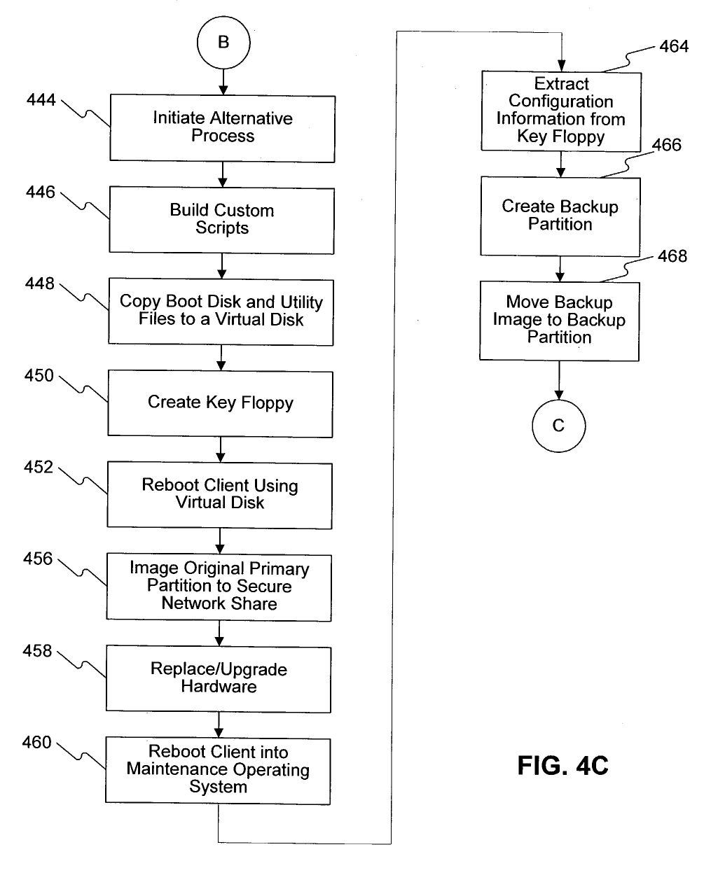

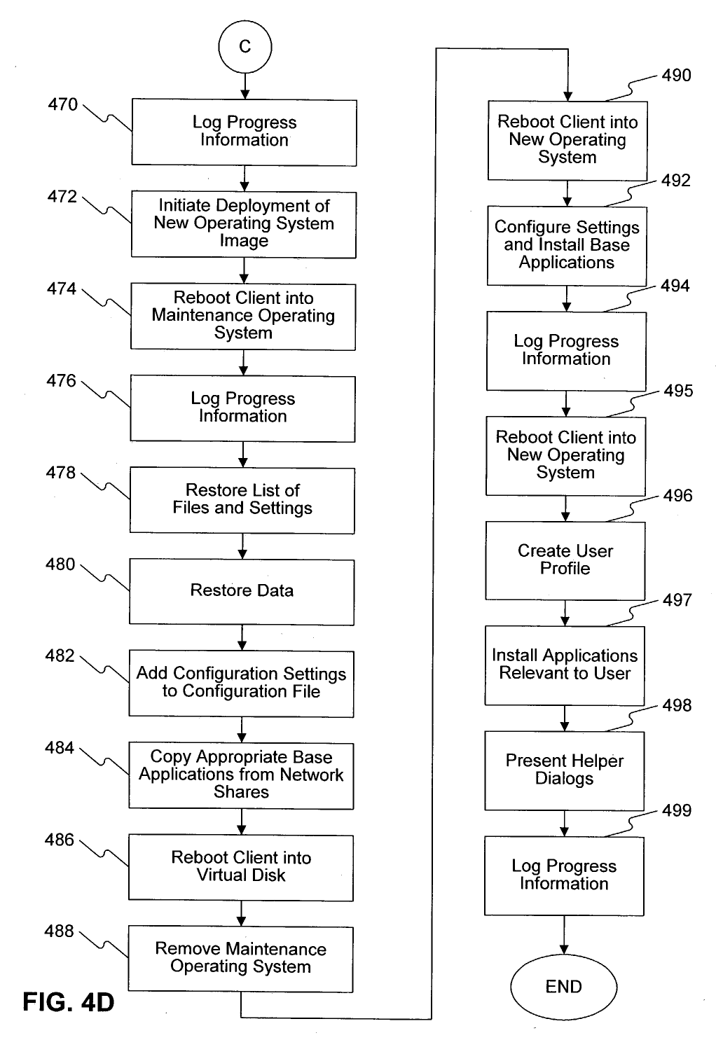

In one embodiment, hard disk drive 202 and/or memory 210 may store an operating system that is to be updated according to an automatic updating process, such as that described below with reference to FIGS. 4A-4D. Further, hard disk 202 and/or memory 210 may store one or more programs that, when executed by CPU 208, perform various processes consistent with embodiments of the present invention. For instance, memory 210 may include a migration application operable to implement the automatic updating process, in addition to various software tools used to implement certain aspects of the automatic updating process.

Software and other applications may be loaded into hard disk drive 202 and/or memory 210 using, for example, a computer readable medium with a software or program application that is read by CD ROM 204 or floppy disk drive 206. Software may also be installed via network 106 and communications device 216. Control of the client as well as data input by a user may be achieved through input device 212, which may comprise a keyboard, a pointer device, a mouse, etc. Data output may be presented to a user of the client through display 214 and/or another output device (such as a printer-not shown). Further, communications device 216 may facilitate communication between the client and other devices (such as server 102 or monitoring station 104) through network 106.

### System Operation

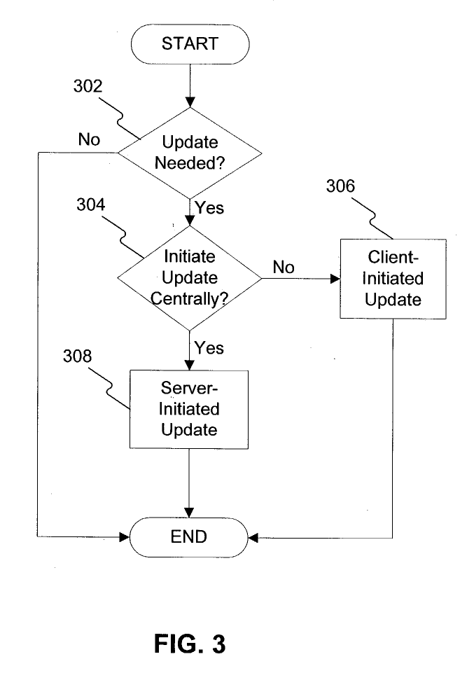

FIG. 3 illustrates a flowchart associated with a generic exemplary method for updating an operating system, consistent with embodiments of the present invention. Although the steps of the flowchart are described in a particular order, one skilled in the art will appreciate that these steps may be performed in a modified or different order. Further, one or more of the steps in FIG. 3 may be performed concurrently or in parallel.

As illustrated in FIG. 3, a server, client, or human operator/user may determine whether any of the clients 108 need an operating system update (step 302). If so, then the server, client, or human operator/user may determine whether the update should be initiated centrally (step 304). When the update is not to be initiated centrally, a client-initiated update occurs (step 306). Otherwise, when the update is to initiated centrally, a server-initiated update occurs (step. 308). If no update is needed, then the process may be terminated.

FIGS. 4A, 4B, 4C, and 4D illustrate flowcharts associated with an exemplary method for client-initiated updating of an operating system, consistent with embodiments of the present invention. Although the steps of the flowcharts are described in a particular order, one skilled in the art will appreciate that these steps may be performed in a modified or different order. Further, one or more of the steps in FIGS. 4A-4D may be performed concurrently or in parallel. One of ordinary skill in the art will appreciate that some steps in FIGS. 4A-4D may be performed by server 102 instead of a client 108.

As illustrated in FIG. 4A, server 102 or one of the clients 108a-108n initiates a migration application (step 402). The migration application may be operable to implement an automatic operating system update. The application may be initiated in any of a number of ways, including a software distribution program such as Microsoft's Systems Management Server (SMS), login scripts, making the migration application available on a Web site, or other tools or methods for software distribution. The migration application may also be initiated manually. For example, to manually initiate the migration application, a user or network administrator may install the migration application on a client 108. A user of the client 108 may subsequently launch the migration application just like the user would launch any other application (e.g., by clicking on an appropriate icon, etc.).

After the migration application is initiated, progress information may be logged (step 404). For example, the migration application may provide information indicative of the status of the operating system update to a database. At this point, progress information may include an indication that the process has been initiated, in addition to other relevant data, time stamps, date stamps, etc. In one embodiment, the database may be located either locally or remotely relative to the client. By way of example, a remote database may be situated in monitoring station 104 or server 102. Alternatively, a local database may be located in one of the clients 108.

After progress information is logged, a determination is made as to whether the client device whose operating system is to be updated meets the minimum hardware requirements (step 406). For example, server 102 or a client 108 may check whether or not client 108 has enough free space on its hard drive to successfully perform the operating system update. Other hardware requirements that may be checked include whether the client 108 has enough random access memory (RAM) available, whether a processor from client 108 is fast enough to run the new operating system, etc. In addition, if hardware has been tagged for replacement, the client 108 may be considered not to meet minimum hardware requirements. Alternatively, the hardware check may occur prior to logging information, or even prior to the initiation of the migration application. If server 102 or client 108 determines that client 108 does not meet minimum hardware requirements (step 406; NO), then client 108 is identified for an alternative process (step 408). Client 108 then proceeds to scan the primary partition of its hard drive for and index all files (step 410). If the client 108 does meet minimum hardware requirements (step 406; YES), then the machine is not identified for the alternative process and processing proceeds directly to step 410.

After scanning the primary partition for and indexing all files (step 410), client 108 scans the primary partition and registry for settings to be preserved (step 412). The registry may be implemented as a central hierarchical database in the operating system that stores information necessary to configure the system for one or more users, applications, and/or hardware devices. Examples of settings that may need to be preserved include, for example, information reflective of the machine name, domain, time zone, applications installed on the machine, peripheral hardware configuration (e.g., printers, PDA's, etc.), user application settings, business specific application settings, etc.

As further illustrated in FIG. 4A, client 108 proceeds to build an index of all of the files and settings to be restored after the new operating system has been placed on the client 108 (step 414). A determination is then made as to whether the machine (e.g., the client for which the index was built) was identified as needing the alternative process (step 416). If the machine was not identified for the alternative process (step 416; NO), then the machine meets the hardware requirements and no hardware is required to be changed. Processing then proceeds to step 418 (FIG. 4B).

As shown in FIG. 4B, custom scripts are built to partition the machine and backup the data (step 418). In this step, client 108 may determine the size of any new partitions and sets up scripts that will be used in connection with a maintenance operating system to implement the partitioning of the hard drive and the backing up of data. Once the custom scripts are built, the client's boot disk and utility files may be copied to the memory of the client as a virtual disk (step 418). A boot disk is a disk that includes key system files from an operating system and that can boot (e.g., start) the computer. A virtual disk is a simulated disk whose data is stored in memory. An operating system may read from and write to a virtual disk as if it were a disk drive. Client 108 is rebooted using the virtual disk (step 422). In this manner, the machine is rebooted without having to change anything on the machine or inserting a floppy disk into the machine. Rebooting in this manner may be necessary to allow a processor on client 108 to receive commands while the client 108 is “in between” operating systems (e.g., before the new operating system takes control and after the old operating system loses control).

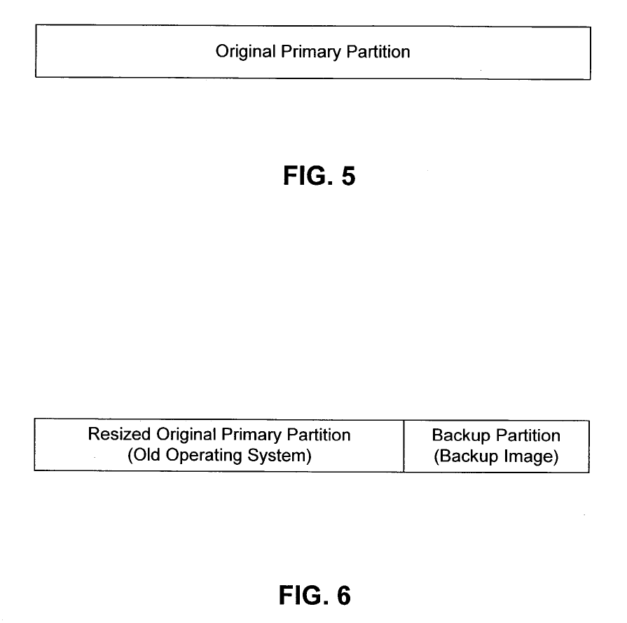

Client 108 proceeds to resize a primary partition on its memory, such as a hard drive of the client (step 426). FIG. 5 is a diagram of a primary partition of an exemplary hard drive configuration before updating has commenced. The partition is resized according to the script-that was previously built in step 418. In one embodiment, the primary partition is resized to make sure that there is enough space available on the hard drive to allow a new partition of suitable size to be created. In one embodiment, a new partition of the hard drive is created (step 428). The new partition is equal in size to the free space remaining on the free disk after the resizing that occurred in step 426. Thereafter, a backup image is created by imaging the original primary partition (e.g., the resized primary partition) into the new partition created in step 428 (step 430). The backup image may be an exact clone or copy of the original primary partition and may include at least an operating system. The backup image facilitates recovering from an error in the updating process. In case of an error, all that is needed is to restore the backup image to get the system back up and running. If there is no backup image, it may be necessary to reinstall the operating system and applications, which could take as long as several days to complete. By way of example, FIG. 6 is a diagram of an exemplary hard drive configuration after creation of a backup partition and backup image.

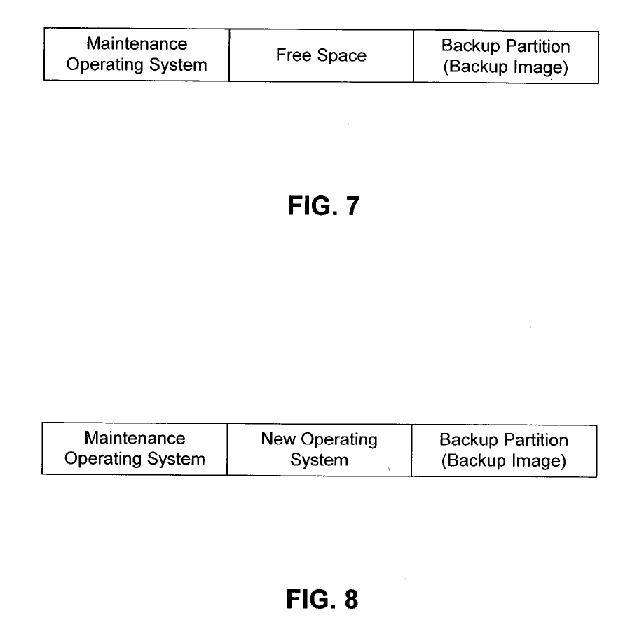

Referring again to FIG. 4B, client 108 may verify the newly created backup image (step 432). This step ensures that the image is correct. If the image is incorrect, then the updating process may be halted and another attempt may be made at creating a correct backup image. Once the backup image has been verified, it is safe for client 108 to delete the contents of the original primary partition (step 434). Deleting the original primary partition creates free space in which images and/or other data may be placed. Client 108 may then image a maintenance operating system into the aforementioned newly created free space (step 436). For example, client 108 may image the Windows Pre-installation Environment (WinPE), available from Microsoft™, into the free space. WinPE is a platform that may replace DOS (Disk Operating System) for operating system deployment. Particularly, WinPE functionally replaces DOS and contains the minimum functionality needed to run Windows Setup, scripts, or custom installation and imaging applications. Using WinPE, it is possible to generally control portions of the operating system update and to automate the pre-installation of an operating system (e.g., Windows) to a workstation or server. Alternatively, other maintenance operating systems may be utilized instead of WinPE. For example, instead of WinPE, DOS, Unix, or Linux could be used as a maintenance operating system. By way of example, FIG. 7 is a diagram of an exemplary hard drive configuration after a maintenance operating system has been added to free space. If the maintenance operating system is already resident on the hard drive, then there may be no need to image the maintenance operating system as explained above. In another embodiment, a maintenance operating system need not be imaged onto the hard drive and may be run from an alternate location. For example, a maintenance operating system may be resident in memory, on a floppy disk, on a CD ROM, on a server, etc.

After the maintenance operating system has been properly imaged into the newly created free space or otherwise made available, the machine (e.g., client 108) is rebooted into the maintenance operating system (step 438). Client 108 subsequently extracts configuration information from the previously created backup partition (step 440). This configuration information relates to the operating system that was in the original primary partition. Processing then proceeds to step 470 (FIG. 4D).

As illustrated in FIG. 4D, client 108 also proceeds to log more progress information on a database located locally or remotely (e.g., in monitoring station 104 or server 102) (step 470). The progress information may be indicative of how far along the update process has made it, and may also include, for example, the date, time, and/or any other information that may facilitate monitoring of the update process.

Deployment of a new operating system into the free space on the hard drive may then be initiated (step 472). During deployment, client 108 may display text and/or graphics indicative of the progress of the deployment. Alternatively, text and graphics may have nothing to do with the progress of the deployment or no text and graphics may be displayed at all. Deployment may be implemented using an imaging process so that the new operating system is imaged onto the hard disk drive of the client. After the new operating system has been imaged into the free space of the hard disk drive, the machine (e.g., client 108) is rebooted into the maintenance operating system (step 474). This rebooting enables the newly created image to be customized. Rebooting may not be necessary if the maintenance operating system has the ability to access the newly imaged/created partition without rebooting (e.g., by reading partition tables, or more generally, by reexamining the medium).

More progress information may be logged indicating how far along the updating process has come, along with date information, time information, and any other relevant information (step 476). For example, progress information may indicate that the new operating system has been deployed and configuration is about to commence. By way of example, FIG. 8 is a diagram of an exemplary hard drive configuration after a new operating system has been deployed to the free space.

At this point in the update process, the deployment of the new operating system is complete, and it is necessary to restore various files, settings, data, and other items important to client 108. For example, client 108 may restore the files and settings that were previously identified in steps 310 through 314 as needing to be preserved (step 478). Data that needs to be restored is restored if possible (step 480), while data that may depend on another event to occur first (e.g., application installation or user login) may be placed into a queue. Configuration settings are also added to the new operating system's configuration file (step 482). For example, configuration settings may be added into a sysprep.inf file. Configuration settings may include information reflective of the machine name, domain, time zone, applications installed on the machine, peripheral hardware configuration (e.g., printers, PDA's, etc.), user application settings, business specific application settings, etc. In addition, applications to install may be added to an automated execution queue for the new operating system (e.g., the commands.txt section of Microsoft's Sysprep). Moreover, client 108 copies appropriate base applications from network shares (step 484). For example, the client may copy base applications from a network file server located at server 102, monitoring station 104, or another location connected to network 106. The client does not yet install the base applications but merely prepares to do so.

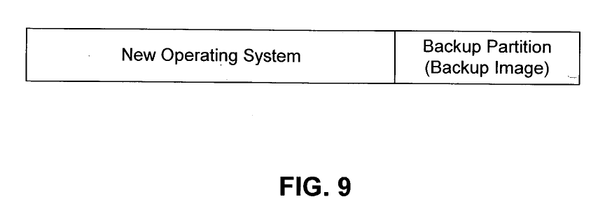

Client 108 is then rebooted into the virtual disk (step 486) in order to remove the maintenance operating system from the hard disk drive (step 488). For purposes of illustration, FIG. 9 is a diagram of an exemplary hard drive configuration after the maintenance operating system has been removed. Once the maintenance operating system has been removed, client 108 is rebooted into the new operating system (step 490). Client 108 may then configure the settings on the machine and install the previously identified based applications (step 492). In one embodiment, a utility such as Sysprep may be used to perform the configuration and installation. Progress information may be logged again, indicating at least that the system is ready for a user (step 494). Date information, time information, and/or other relevant information may also be logged.

Client 108 is then rebooted into the new operating system (step 495). This time, however, a user may log into the machine for the first time since deployment of the new operating system. The user may also create a user profile (step 496), making it possible to complete user data and settings. Thereafter, applications relevant to the user may be installed (step 497). For example, business applications based on user and/or group associations may be installed if necessary. Helper dialogs may also be presented to the user to help finish configuration of the new operating system, for settings new to the new operating system or settings that cannot be reasonably migrated from the old operating system (step 498). Thereafter, progress information may be logged indicating that the update process has been completed (step 499). Date information, time information, and/or other relevant information may also be logged.

FIG. 4C illustrates a flowchart of the steps that may be performed when client 108 does not meet minimum requirements and is identified as needing the alternative process. Continuing from step 416 above, when it is determined that the machine has been identified for the alternative process, that process is initiated (step 444). The amount of used space on the hard disk drive of the machine (e.g., a client 108) is noted for later use.

Custom scripts are built to partition client 108 and backup the data (step 346). In this step, client 108 determines the size of any new partitions and sets up scripts that will be used to implement the partitioning of the hard drive and the backing up of data. Once the custom scripts are built, the client's boot disk and utility files are copied to the memory of the client as a virtual disk (step 448). At this point, a user's interaction is needed in order to create a key floppy (step 450). For example, a user may insert a blank floppy disk into client 108 so that configuration information specific to the machine may be saved onto the disk. The key floppy may be utilized to tie data from the old machine (e.g., the machine before the hardware replacement/upgrade) to data for the new machine (e.g., the upgraded machine). For example, the key floppy may store data reflective of an identification of the old machine. In addition, the key floppy may store settings specific to execution of the operating system update, such as database locations or network storage locations. This data may serve to inform the new machine what machine it is replacing, so that it may access the old machine's data wherever it is stored.

Thereafter, the client 108 is rebooted into the virtual disk (step 452). In this manner, the machine is rebooted without having to change anything on the machine or inserting a floppy disk into the machine. Rebooting in this manner may be necessary to allow a processor on client 108 to receive commands while the client 108 is “in between” operating systems (e.g., before the new operating system takes control and after the old operating system loses control).

After rebooting, the client 108 may proceed to image an original primary partition (e.g., the partition that contains the old operating system) to a secure network share (step 456). For example, the image of the original primary partition may be sent to a network file server located at server 102, monitoring station 104, or another location connected to network 106. Alternatively, the original primary partition may be imaged to media connected to the client 108 (e.g., Zip Disk, spare drive, CD burner, etc.). With the image on the network share, the user may proceed to replace or upgrade hardware on the machine (step 458). More particularly, the user replaces or upgrades hardware so that the machine meets the minimum requirements necessary for completing the update process. The required changes to the hardware may be previously determined (e.g., when the determination was made that the machine did not meet minimum requirements). Alternatively, the whole machine may be completely replaced, if necessary.

After the user makes the required changes to the hardware, client 108 may reboot into a maintenance operating system (step 460). For example, client 108 may reboot into WinPE or another suitable maintenance operating system. The maintenance operating system may have been previously loaded onto the client 108 or imaged onto the client 108 before rebooting into it. Next, the user may insert the key floppy into the client 108 so that relevant configuration information may be extracted from the key floppy (step 464). As previously explained, a maintenance operating system may be resident on a hard drive, in memory, on a floppy disk, on a CD ROM, on a server, etc.

Client 108 proceeds to create a backup partition from part of the primary partition on its hard disk drive (step 466). The backup partition has a size large enough to ensure that it can hold an image of the original primary partition. Thereafter, a backup image is created by imaging the original primary partition from the secure network share into the backup partition created in step 466 (step 468). The backup image may be an exact clone or copy of the original primary partition and may include at least an operating system. Processing next goes to step 470, where progress information is logged, and continues on through the remaining steps as previously explained with reference to steps 470-499.

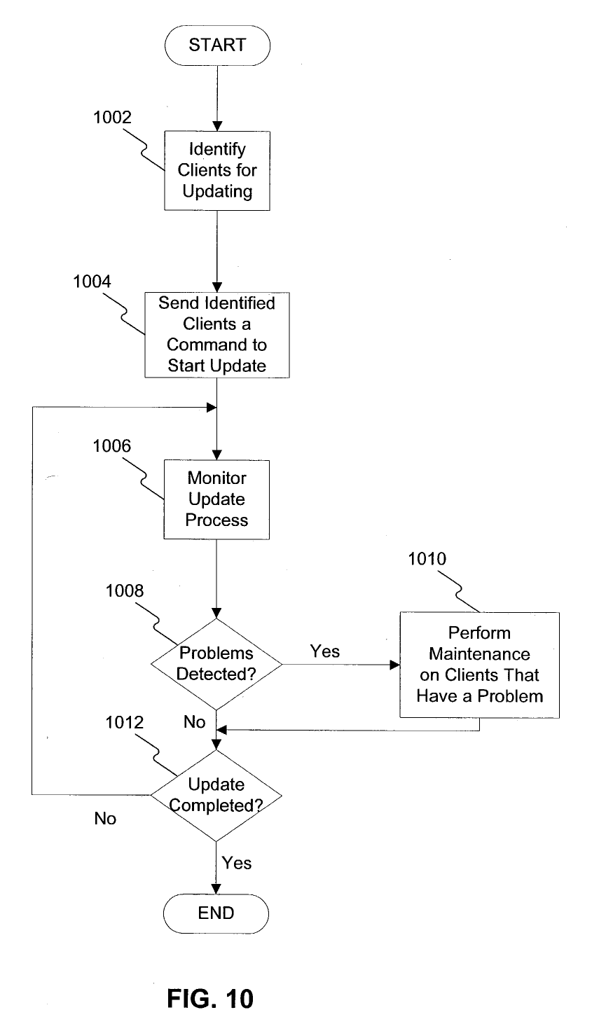

FIG. 10 illustrates a flowchart associated with an exemplary method for server-initiated updating of an operating system, consistent with embodiments of the present invention. Although the steps of the flowchart are described in a particular order, one skilled in the art will appreciate that these steps may be performed in a modified or different order. Further, one or more of the steps in FIG. 10 may be performed concurrently or in parallel.

As illustrated in FIG. 10, server 102 may identify one or more clients 108 for an operating system update (step 1002). For example, server 102 may select clients 108 for updating as part of regular machine maintenance or as part of a large batch of updates. Once the server 102 has determined which clients should have their operating systems updated, it may send those clients a command to commence updating operations (step 1004). Operating system updates may be implemented, for example, using updating operations in accordance with FIGS. 4A-4D.

As updates on the clients 108 proceed, the server 102 may monitor the progress of the updates (step 1006). For example, a client 108 may periodically report back to server 102 to allow an administrator to check the progress of the update. By checking the progress of the updates in this manner, the server 102 may determine whether any of the clients 108 is having a problem with its update (step 1008). If a problem or error on one or more clients 108 is detected, then an administrator at server 102 may perform appropriate maintenance on the client(s) to resolve the problem(s) (step 1010). Once the maintenance has been completed or if no problems have been detected, the updates continue as normal. Based on progress information from the clients 108, the server 102 may determine whether all of the updates are complete (step 1012). If not, server 102 may continue to monitor the updates as explained above.

Consistent with embodiments of the present invention, certain features and elements of the invention may be implemented using commercially available software, such as PowerQuest DeployCenter and PartitionMagic Pro available from PowerQuest Corporation. Other imaging and partitioning tools may also be used to implement embodiments of the invention. For example, Symantec's Ghost™ software or Microsoft's RIS (Remote Installation Services) may be used to implement certain features and aspects of the present invention.

While the present invention has been described in connection with various embodiments, many modifications will be readily apparent to those skilled in the art. One skilled in the art will also appreciate that all or part of the systems and methods consistent with the present invention may be stored on or read from computer-readable media, such as secondary storage devices, like hard disks, floppy disks, and CD-ROM; a carrier wave received from a network such as the Internet; or other forms of ROM or RAM. Accordingly, embodiments of the invention are not limited to the above described embodiments and examples, but instead is defined by the appended claims in light of their full scope of equivalents.

What is claimed is:

1. A method for updating an operating system in a computer including a disk drive that stores an operating system to be updated, comprising:
creating a backup image of a first partition of the disk drive;
deleting the first partition to create free space on the disk drive;
placing an image of a maintenance operating system into the free space, wherein the maintenance operating system is operable to manage an operating system update; and
updating the stored operating system under control of the maintenance operating system.

2. The method of claim 1, wherein creating a backup image comprises:
resizing the first partition of the disk drive to create enough free space on the disk drive to store the backup image of the first partition;
creating a second partition on the disk drive using the free space created by the resizing; and
placing an image of the resized partition into the second partition, wherein the image of the resized partition functions as the backup image.

3. The method of claim 2, further comprising:
gathering, prior to the resizing, information to be restored after the operating system update.

4. The method of claim 3, wherein gathering information comprises:
scanning the computer for the information to be restored; and
building an index of the information to be restored.

5. The method of claim 4, wherein scanning comprises scanning the first partition for the information to be restored.

6. The method of claim 4, wherein scanning comprises scanning a registry for the information to be restored.

7. The method of claim 3, wherein the information to be restored includes at least one of files and configuration settings.

8. The method of claim 2, further comprising:
building, prior to the resizing, scripts operable to partition the hard drive and backup data; and
rebooting, prior to the resizing, the computer using a virtual disk.

9. The method of claim 1, further comprising:
verifying the backup image before deleting the first partition.

10. The method of claim 1, wherein updating the stored operating system comprises:
placing an image of a new operating system into the free space.

11. The method of claim 1, wherein updating the stored operating system comprises:
rebooting the computer into the maintenance operating system;
placing an image of a new operating system into the free space;
restoring information that was previously identified as information to be restored after the operating system update;
removing the maintenance operating system from the free space; and
rebooting the computer into the new operating system.

12. The method of claim 1, further comprising:
periodically logging progress information indicative of a status of the operating system update.

13. The method of claim 1, further comprising:
determining whether the computer meets minimum hardware requirements for the operating system update; and
identifying the computer for an alternative process based on a determination that the computer does not meet minimum hardware requirements.

14. The method of claim 13, wherein the alternative process is initiated if the computer is identified for the alternative process, the alternative process comprising:
copying information specific to the computer to a floppy disk;
placing the backup image of the first partition in a secure network share;
upgrading hardware associated with the computer such that the computer meets minimum hardware requirements;
extracting the information specific to the computer from the floppy disk;
creating a second partition on the disk drive; and
moving the backup image from the network share to the second partition.

15. A method for updating an operating system of a client, comprising:
resizing a partition of a disk drive of the client to create enough first free space on the disk drive to store a backup image of the resized partition, wherein the resized partition includes an operating system to be updated;
creating a new partition on the disk drive using the first free space;
placing an image of the resized partition into the new partition, wherein the image of the resized partition functions as the backup image;
deleting the resized partition to create second free space on the disk drive;
placing an image of a maintenance operating system into the second free space, wherein the maintenance operating system is operable to manage an operating system update;
imaging, under control of the maintenance operating system, a new operating system into the second free space; and removing the maintenance operating system from the second free space.

16. An apparatus for updating an operating system in a client including a disk drive that stores an operating system to be updated, comprising:
means for creating a backup image of a first partition of the disk drive;
means for deleting the first partition to create free space on the disk drive;
means for placing an image of a maintenance operating system into the free space, wherein the maintenance operating system is operable to manage an operating system update; and
means for updating the stored operating system under control of the maintenance operating system.

17. The apparatus of claim 16, wherein the means for creating a backup image comprises:
means for resizing the first partition of the disk drive to create enough free space on the disk drive to store the backup image of the first partition;
means for creating a second partition on the disk drive using the free space created by the resizing; and
means for placing an image of the resized partition into the second partition, wherein the image of the resized partition functions as the backup image.

18. The apparatus of claim 17, further comprising:
means for gathering, prior to the resizing, information to be restored after the operating system update.

19. The apparatus of claim 18, wherein the means for gathering comprises:
means for scanning the client for the information to be restored; and
means for building an index of the information to be restored.

20. The apparatus of claim 19, wherein the means for scanning scans a first partition for the information to be restored.

21. The apparatus of claim 19, wherein the means for scanning scans a registry for the information to be restored.

22. The apparatus of claim 18, wherein the information to be restored includes at least one of files and configuration settings.

23. The apparatus of claim 17, further comprising:
means for building, prior to the resizing, scripts operable to partition the hard drive and backup data; and
means for rebooting, prior to the resizing, the client using a virtual disk.

24. The apparatus of claim 16, further comprising:
means for verifying the backup image before deleting the first partition.

25. The apparatus of claim 16, wherein the means for updating comprises:
means for placing an image of a new operating system into the free space.

26. The apparatus of claim 16, wherein the means for updating comprises:
means for rebooting the client into the maintenance operating system;
means for placing an image of a new operating system into the free space;
means for restoring information that was previously identified as information to be restored after the operating system update;
means for removing the maintenance operating system from the free space; and
means for rebooting the client into the new operating system.

27. The apparatus of claim 16, further comprising:
means for periodically logging progress information indicative of a status of the operating system update.

28. The apparatus of claim 16, further comprising:
means for determining whether the client meets minimum hardware requirements for the operating system update; and
means for identifying the client for an alternative process based on a determination that the client does not meet minimum hardware requirements.

29. An apparatus for updating an operating system, comprising:
means for resizing a partition of a disk drive to create enough first free space on the disk drive to store a backup image of the resized partition, wherein the resized partition includes an operating system to be updated;
means for creating a new partition on the disk drive using the first free space;
means for placing an image of the resized partition into the new partition, wherein the image of the resized partition functions as the backup image;
means for deleting the resized partition to create second free space on the disk drive;
means for placing an image of a maintenance operating system into the second free space, wherein the maintenance operating system is operable to manage an operating system update;
means for imaging, under control of the maintenance operating system, a new operating system into the second free space; and
means for removing the maintenance operating system from the second free space.

30. An apparatus for updating an operating system in a computer including a disk drive that stores an operating system to be updated, comprising:
a memory storing a program that creates a backup image of a first partition of the disk drive; deletes the first partition to create free space on the disk drive; places an image of a maintenance operating system into the free space, wherein the maintenance operating system is operable to manage an operating system update; and updates the stored operating system under control of the maintenance operating system; and
a processor that runs the program.

31. An apparatus for updating an operating system, comprising:
a memory storing a program that resizes a partition of a disk drive to create enough first free space on the disk drive to store a backup image of the resized partition, wherein the resized partition includes an operating system to be updated;
creates a new partition on the disk drive using the first free space; places an image of the resized partition into the new partition, wherein the image of the resized partition functions as the backup image; deletes the resized partition to create second free space on the disk drive; places an image of a maintenance operating system into the second free space, wherein the maintenance operating system is operable to manage an operating system update; images, under control of the maintenance operating system, a new operating system into the second free space; and removes the maintenance operating system from the second free space; and
a processor that runs the program.

32. A computer-readable medium containing instructions for performing a method for updating an operating system in a computer including a disk drive that stores an operating system to be updated, the method comprising:
creating a backup image of a first partition of the disk drive;
deleting the first partition to create free space on the disk drive;
placing an image of a maintenance operating system into the free space,
wherein the maintenance operating system is operable to manage an operating system update; and
updating the stored operating system under control of the maintenance operating system.

33. A computer-readable medium containing instructions for performing a method for updating an operating system of a computer, the method comprising:
resizing a partition of a disk drive of the computer to create enough first free space on the disk drive to store a backup image of the resized partition, wherein the resized partition includes an operating system to be updated;
creating a new partition on the disk drive using the first free space;
placing an image of the resized partition into the new partition, wherein the image of the resized partition functions as the backup image;
deleting the resized partition to create second free space on the disk drive;
placing an image of a maintenance operating system into the second free space, wherein the maintenance operating system is operable to manage an operating system update;
imaging, under control of the maintenance operating system, a new operating system into the second free space; and
removing the maintenance operating system from the second free space.

34. A method for updating an operating system of a client, comprising:
resizing a partition of a disk drive of the client to create enough first free space on the disk drive to store a backup image of the resized partition, wherein the resized partition includes an operating system to be updated;
creating a new partition on the disk drive using the first free space;
placing an image of the resized partition into the new partition, wherein the image of the resized partition functions as the backup image;
deleting the resized partition to create second free space on the disk drive; and
imaging, under control of a maintenance operating system, a new operating system into the second free space, wherein the maintenance operating system is operable to manage an operating system update.

35. A method for updating an operating system of at least one client, comprising:
identifying at least one client for an operating system update; and
sending each of the identified clients a command to commence an operating system update, wherein each of the identified clients is operable to:
create a backup image of a first partition of a disk drive on the identified client;
delete the first partition to create free space on the disk drive;
place an image of a maintenance operating system into the free space, wherein the maintenance operating system is operable to manage an operating system update; and
update an operating system stored on the disk drive under control of the maintenance operating system.

36. The method of claim 35, further comprising:
monitoring the progress of each operating system update on the identified clients.

37. An apparatus for updating an operating system of at least one client, comprising:
means for identifying at least one client for an operating system update; and
means for sending each of the identified clients a command to commence an operating system update, wherein each of the identified clients comprises:
means for creating a backup image of a first partition of a disk drive on the identified client;
means for deleting the first partition to create free space on the disk drive;
means for placing an image of a maintenance operating system into the free space, wherein the maintenance operating system is operable to manage an operating system update; and
means for updating an operating system stored on the disk drive under control of the maintenance operating system.

38. The apparatus of claim 37, further comprising:
means for monitoring the progress of each operating system update on the identified clients.

39. An apparatus for updating an operating system of at least one client, comprising:
a memory storing a program that identifies at least one client for an operating system update, and sends each of the identified clients a command to commence an operating system update, wherein each of the identified clients is operable to:
create a backup image of a first partition of a disk drive on the identified client;
delete the first partition to create free space on the disk drive;
place an image of a maintenance operating system into the free space, wherein the maintenance operating system is operable to manage an operating system update; and
update an operating system stored on the disk drive under control of the maintenance operating system; and
a processor that runs the program.

40. A computer-readable medium containing instructions for updating an operating system of at least one client, the method comprising:
identifying at least one client for an operating system update; and
sending each of the identified clients a command to commence an operating system update, wherein each of the identified clients is operable to:
create a backup image of a first partition of a disk drive on the identified client;
delete the first partition to create free space on the disk drive;
place an image of a maintenance operating system into the free space,
wherein the maintenance operating system is operable to manage an operating system update; and
update an operating system stored on the disk drive under control of the maintenance operating system.

41. A system for updating an operating system of at least one client, comprising:
a network;
a plurality of clients; and
a server connected to the plurality of clients through the network, the server operable to identify at least one client for an operating system update, and send each of the identified clients a command to commence an operating system update, wherein each of the identified clients is operable to:
create a backup image of a first partition of a disk drive on the identified client;
delete the first partition to create free space on the disk drive;
place an image of a maintenance operating system into the free space, wherein the maintenance operating system is operable to manage an operating system update; and
update an operating system stored on the disk drive under control of the maintenance operating system.

42. A method for updating an operating system of at least one client, comprising:
identifying at least one client for an operating system update; and
sending each of the identified clients a command to commence an operating system update, wherein each of the identified clients is operable to:
resize a partition of a disk drive of the identified client to create enough first free space on the disk drive to store a backup image of the resized partition, wherein the resized partition includes an operating system to be updated;
create a new partition on the disk drive using the first free space;
place an image of the resized partition into the new partition, wherein the image of the resized partition functions as the backup image;
delete the resized partition to create second free space on the disk drive;
place an image of a maintenance operating system into the second free space, wherein the maintenance operating system is operable to manage an operating system update;
image, under control of the maintenance operating system, a new operating system into the second free space; and
remove the maintenance operating system from the second free space.
